(19) United States
(12) Patent Application Publication
(10) Pub. No.: US 2016/0231043 A1
(43) Pub. Date: Aug. 11, 2016

(54) AIR INTAKE FOR REFRIGERATED CONTAINER ASSEMBLY

(71) Applicant: CARRIER CORPORATION, Farmington, CT (US)

(72) Inventors: James Casasanta, Auburn, NY (US); Mary D. Saroka, Syracuse, NY (US)

(73) Assignee: Carrier Corporation, Farmington, CT (US)

(21) Appl. No.: 15/029,826

(22) PCT Filed: Oct. 15, 2014
(86) PCT No.: PCT/US2014/060596

§ 371 Date: Apr. 15, 2016

Related U.S. Application Data
(60) Provisional application No. 61/892,223, filed on Oct. 17, 2013.

(51) Int. Cl. F25D 11/00; F02B 63/06; B60P 3/20; F25B 27/02; F25D 17/06

(52) U.S. Cl. CPC F25D 11/003; F25B 27/02; F25D 17/067; B60P 3/20; F02B 63/06; F25B 2327/001

(57) ABSTRACT

A refrigerated transportation cargo container includes a transportation cargo container (10) and a refrigeration unit (24) located at an end of the transportation cargo container (10) to provide a flow of supply air (40) for the transportation cargo container (10). The refrigeration unit (24) includes a compressor (26) and an engine (36) operably connected to the compressor (26) to drive the compressor (26). An engine air intake (54) is located at a top wall (12) of the cargo container (10) to direct a flow of engine intake air (52) from outside the cargo container (10) toward the engine (36), and an air channel (50) extends from the engine air intake (54) to the engine (36).

### BACKGROUND OF THE INVENTION

The subject matter disclosed herein relates to refrigeration systems. More specifically, the subject matter disclosed herein relates to refrigeration of containers utilized to store and ship cargo.

A typical refrigerated cargo container or refrigerated truck trailer, such as those utilized to transport a cargo via sea, rail or road, is a container modified to include a refrigeration unit located at one end of the container. The refrigeration unit includes a compressor, condenser, expansion valve and evaporator serially connected by refrigerant lines in a closed refrigerant circuit in accord with known refrigerant vapor compression cycles. A power unit, including an engine, drives the compressor of the refrigeration unit, and is typically diesel powered, or in other applications natural gas powered. In many truck/trailer transport refrigeration systems, the compressor is driven by the engine shaft either through a belt drive or by a mechanical shaft-to-shaft link. In other systems, the engine drives a generator that generates electrical power, which in turn drives the compressor.

Typically, air intakes for the refrigeration unit engine are located directly below the refrigeration unit. The air intakes are constructed of molded rubber or rubber-like materials that are costly to manufacture, which are then assembled to the container. Hoses are fitted to the air intakes to convey the air from the air intakes to the engine. While such a position of the air intakes is good for preventing water ingress into the air intakes, the air flowed into the intake can have an undesired high temperature, when compared air flowing along the side of the container or over the top of the container. The air at the bottom of the container is typically warmer due to radiant and convective heating from the pavement and from the tractor engine. Additionally, the intake air may be inadvertently heated by being routed past the refrigeration unit condenser, and the heated air flowing off of the condenser.

### BRIEF DESCRIPTION OF THE INVENTION

In one embodiment, a refrigerated transportation cargo container includes a transportation cargo container and a refrigeration unit located at an end of the transportation cargo container to provide a flow of supply air for the transportation cargo container. The refrigeration unit includes a compressor and an engine operably connected to the compressor to drive the compressor. An engine air intake is located at a top wall of the cargo container to direct engine intake air from outside the cargo container through the engine air intake, and an air channel extends from the engine air intake to the engine.

In another embodiment, a method of operating a refrigeration unit for a refrigerated transportation cargo container includes operably connecting an engine to a compressor of the refrigeration unit and locating an engine air intake at a top wall of the cargo container. A flow of engine intake air is directed downwardly from outside of the cargo container and through the engine air intake to the engine, thereby proving the flow of engine air for engine operation.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic illustration of an embodiment of a refrigerated transportation cargo container;

FIG. 2 is a schematic illustration of an embodiment of a refrigeration unit for a refrigerated transportation cargo container;

FIG. 3 is a cross-sectional view of an embodiment of an engine air passage for a refrigeration unit of a refrigerated transportation cargo container;

FIG. 4 is another cross-sectional view of an embodiment of an engine air passage for a refrigeration unit of a refrigerated transportation cargo container;

FIG. 5 is a cross-sectional view of another embodiment of an engine air passage for a refrigeration unit of a refrigerated transportation cargo container; and

FIG. 6 is a cross-sectional view of yet another embodiment of an engine air passage for a refrigeration unit of a refrigerated transportation cargo container.

The detailed description explains embodiments of the invention, together with advantages and features, by way of example with reference to the drawing.

### DETAILED DESCRIPTION OF THE INVENTION

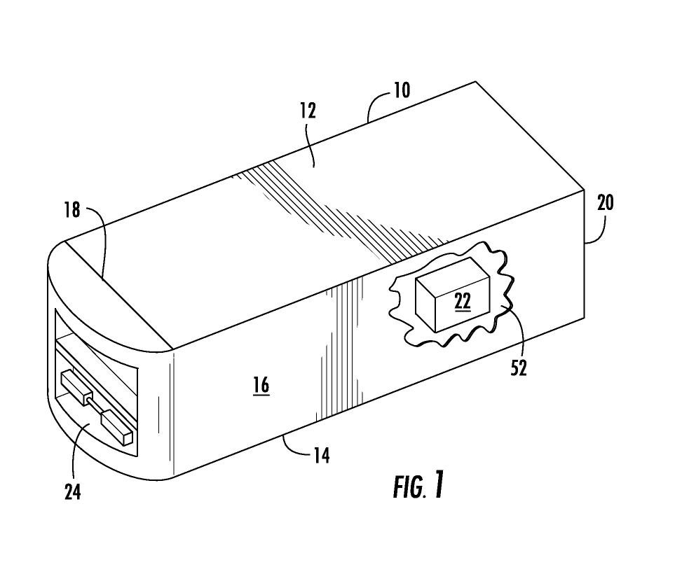

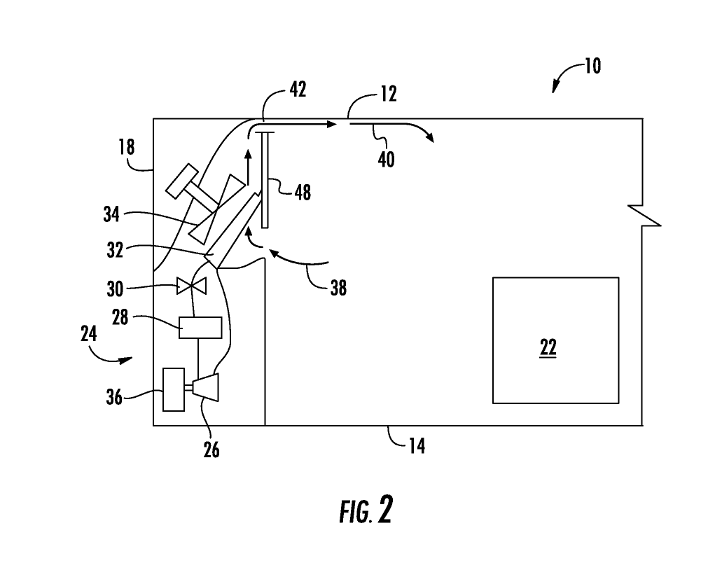

Shown in FIG. 1 is an embodiment of a refrigerated cargo container 10. The cargo container 10 is formed into a generally rectangular construction, with a top wall 12, a directly opposed bottom wall 14, opposed side walls 16 and a front wall 18. The cargo container 10 further includes a door or doors (not shown) at a rear wall 20, opposite the front wall 18. The cargo container 10 is configured to maintain a cargo 22 located inside the cargo container 10 at a selected temperature through the use of a refrigeration unit 24 located at the container 10. The cargo container 10 is mobile and is utilized to transport the cargo 22 via, for example, a truck, a train or a ship. The refrigeration unit 24 is located at the front wall 18, and includes a compressor 26, a condenser 28, an expansion valve 30, an evaporator 32 and an evaporator fan 34 (shown in FIG. 2). The compressor 26 is operably connected to an engine 36 which drives the compressor 26. In some embodiments, the engine 36 is diesel powered. In other embodiments, the engine is powered by another fuel such as natural gas. Further, the engine is connected to the compressor in one of several ways, such as a direct shaft drive, a belt drive, one or more clutches, or via an electrical generator. Referring to FIG. 2, return airflow 38 flows into the refrigeration unit 24 from the cargo container 10 through a refrigeration unit inlet 60, and across the evaporator 32 via the evaporator fan 34, thus cooling the return airflow 38 to a selected temperature. The cooled return airflow 38, now referred to as supply airflow 40 is then supplied into the container 10 through a refrigeration unit outlet 42, which in some embodiments is located near the top wall 12 of the cargo container 10. The supply air 40 cools the cargo 22 in the cargo container 10. It is to be appreciated that the refrigeration unit 24 can further be operated in reverse to warm the cargo container 10 when, for example, the outside temperature is very low.

The evaporator 32 and evaporator fan 34 are segregated from the remaining components by an inner panel, or POD 48 to reduce undesired heating of the evaporator 32 and return airflow 38 by radiant heat from, for example, the condenser 28 and the engine 36. The POD 48 is formed from, for example, a sheet metal forming or molding process and is secured to the front wall 18 of the container 10.

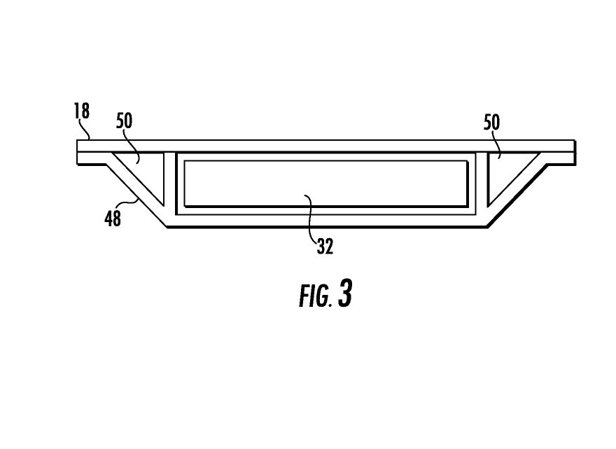

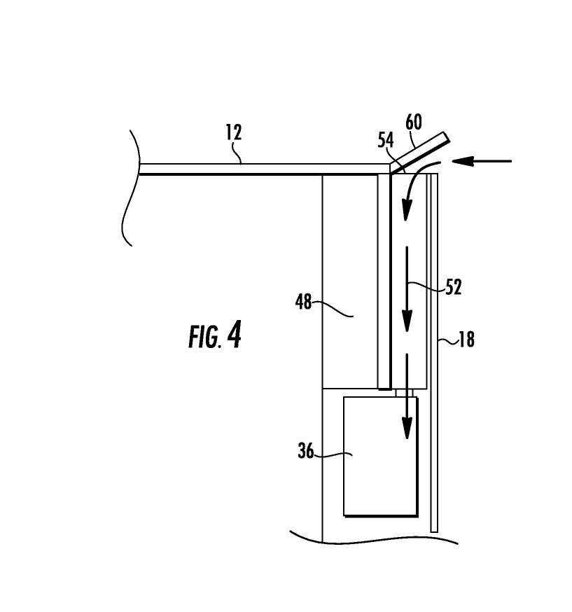

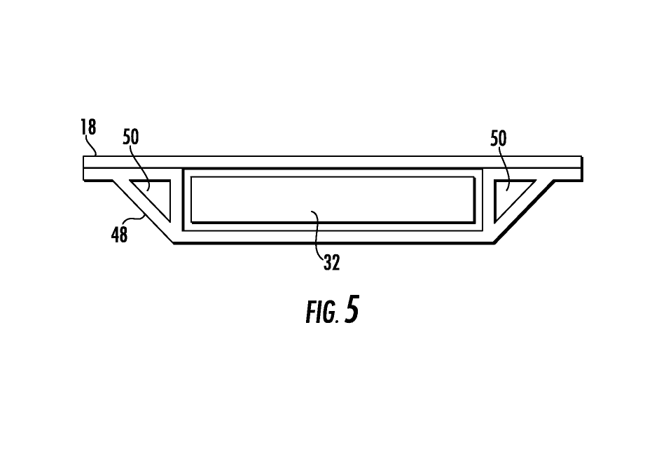

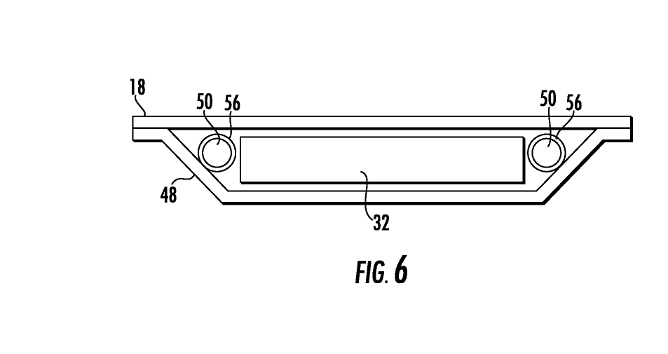

Referring now to FIG. 3, an airflow channel 50 is formed between the POD 48 and the front wall 18 of the container 10, laterally adjacent to the evaporator 32. Referring now to FIG. 4, an air intake 54 located at the top wall 12 of the cargo container directs engine intake air 52 from outside the cargo container 10 into the airflow channel 50 and toward the engine 36 for operation thereof. The airflow channel 50 may be in the form of a passage bounded by the POD 48 and the front wall 18, or may be a tubular structure formed in the POD 48, as shown in FIG. 5. Further, as shown in FIG. 6, a tube 56 may be extended through the airflow channel 50 to direct the intake air 52 to the engine 36. In some embodiments, the POD 48 includes a feature to prevent water from entering the air intake 54, such as an extension 60 angled over the air intake opening such as shown in FIG. 4 to prevent water ingress into the air intake 54, while still allowing sufficient airflow into the air intake 54. Alternatively or additionally, other elements, such as an air/water separator (not shown) may be positioned in the airflow channel 50 to separate water from the intake air 52 before the intake air reaches the engine 36.

Positioning the air intake 54 at the top wall 12 of the container 10 and utilizing the POD 48 to direct the intake air 52 toward the engine 36 has numerous advantages over refrigeration units 24 with air intakes at a bottom wall of the container. Further, in some embodiments, flowing the intake air 52 via the POD 48 past the evaporator 32 results in cooling of the intake air 52. The resulting intake air 52 is cleaner and cooler than that from the bottom wall, as there is reduced radiant and convective heating of the intake air 52. Further, by utilizing the airflow channel 50 formed by the POD 48, a length of hose necessary to direct the intake air 52 into the engine is reduced or eliminated, thereby reducing cost and complexity. Further, the cleaner and cooler intake air 52 improves engine 36 performance, especially given the trend toward downsizing and/or turbocharging engines for container use to improve fuel efficiency.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A refrigerated transportation cargo container comprising:
a transportation cargo container;
a refrigeration unit disposed at an end of the transportation cargo container to provide a flow of supply air for the transportation cargo container, the refrigeration unit including:
a compressor;
an engine operably connected to the compressor to drive the compressor;
an engine air intake at a top wall of the cargo container to intake engine air from outside the cargo container; and
an air channel extending from the engine air intake to the engine.

2. The refrigerated transportation cargo container of claim 1, wherein the air channel is located between an inner panel and a front wall of the cargo container.

3. The refrigerated transportation cargo container of claim 2, further comprising a tubular member extended between the inner panel and the front wall.

4. The refrigerated transportation cargo container of claim 1, wherein the air channel is formed in an inner panel of the cargo container.

5. The refrigerated transportation cargo container of claim 2, wherein the inner panel separates an evaporator of the refrigeration unit from the engine.

6. The refrigerated transportation cargo container of claim 1, wherein the engine is a diesel-powered or natural gas-powered engine.

7. A method of operating a refrigeration unit for a refrigerated transportation cargo container comprising:
operably connecting an engine to a compressor of the refrigeration unit;
locating an engine air intake at a top wall of the cargo container; and
directing a flow of engine intake air downwardly from outside of the cargo container, and through the engine air intake to the engine, thereby proving the flow of engine air for engine operation.

8. The method of claim 7, comprising directing the intake air from the top wall of the cargo container to the engine via an airflow passage defined between a front wall of the cargo container and an inner panel of the cargo container.

9. The method of claim 8, further comprising directing the engine intake air to the engine via a tubular member disposed in the airflow passage.

10. The method of claim 7, further comprising separating an evaporator of the refrigeration unit from the engine via an inner panel of the cargo container

11. The method of claim 10, further comprising directing the engine intake air toward the engine via an airflow passage formed into the inner panel of the cargo container.

12. The method of claim 7, further comprising flowing the engine intake air past an evaporator of the refrigeration unit thereby cooling the engine intake air

13. The method of claim 7, wherein the engine is a diesel-powered of natural gas-powered engine.
